(19) United States
(12) Patent Application Publication
(10) Pub. No.: US 2025/0074381 A1
(43) Pub. Date: Mar. 6, 2025

(54) BRAKE CALIPER ARRANGEMENT

(71) Applicant: ZF Active Safety GmbH, Koblenz (DE)

(72) Inventor: Guido Zenzen, Macken (DE)

(21) Appl. No.: 18/818,943

(22) Filed: Aug. 29, 2024

(30) Foreign Application Priority Data
Aug. 30, 2023 (DE) 102023123378.5

(51) Int. Cl. B60T 13/74; F16D 55/00; F16D 55/226; F16D 65/00; F16D 65/18; F16D 121/24; F16D 125/40

(52) U.S. Cl. CPC B60T 13/746; F16D 55/226; F16D 65/005; F16D 65/0068; F16D 65/18; F16D 2055/0016; F16D 2121/24; F16D 2125/40

(57) ABSTRACT

A brake caliper arrangement for a disc brake, and a disc brake for such a brake caliper arrangement is disclosed. The brake caliper arrangement comprises a brake caliper which has a carrier structure and a housing with a cavity, a brake piston which is mounted axially movably in the cavity, and a spindle drive having a spindle which is mounted in the cavity so as to be rotatable relative to the housing. A spindle nut which is axially drivable via the spindle and mounted axially displaceably. The spindle drive can be actuated such that it can be placed in a first actuation state and in a second actuation state, wherein the spindle nut in the first actuation state exerts a force on the brake piston in the axial direction. The spindle nut in the second actuation state exerts no force on the brake piston in the axial direction. Furthermore, the brake caliper arrangement has a clamping device which exerts a force on the spindle in the axial direction such that in the second actuation state of the spindle drive, the spindle is mounted play-free relative to the housing in the axial direction.

### CROSS-REFERENCE TO RELATED APPLICATIONS

This application claims priority to German Application No. 102023123378.5, filed on Aug. 30, 2023, the disclosure of which is incorporated herein by reference in its entirety.

### TECHNICAL FIELD

The disclosure concerns a brake caliper arrangement for a disc brake. The disclosure furthermore concerns a disc brake with such a brake caliper arrangement and an electromechanically drivable spindle drive.

### BACKGROUND

Such brake caliper arrangements and such disc brakes are normally used when the disc brake concerned must fulfil a hydraulic service brake function and an electric parking brake function. The use of the disclosure for purely electromechanically actuated disc brakes is however also possible in principle. In the description below however, the disclosure is described primarily in relation to a hydraulically actuated service brake in combination with an electromechanically actuated parking brake.

Such disc brakes and also corresponding brake caliper arrangements are known from the prior art. For example, DE 10 2011 121 765 A1 discloses a disc brake which can be actuated hydraulically and by a spindle/nut arrangement which can be driven by electric motor.

FIG. 1 also shows a brake caliper arrangement 1′ from the prior art. It is shown there in an actuation state of the spindle drive 50′ in which the spindle nut 65′ is in a retracted position relative to the brake piston 30′ and separated from the inside of the brake piston end wall 31′. In this actuation state, the spindle drive 50′ is not axially clamped; it is however axially secured by a bearing plate 61′, a thrust bearing 63′ and a locking ring on the drive peg 55′ of the spindle 51′. In other words, the spindle drive 50′ cannot substantially move axially relative to the housing 15′, but usually a degree of axial play is provided in the region of the spindle bearing to allow mounting of the spindle 51′ and also of the entire spindle drive 50′. In operation of an associated vehicle, this axial play often leads to the spindle 51′ or the entire spindle drive 50′ moving to and fro within the axial play, and hence causing a rattling noise, i.e. sound emissions. It is known that a fine dimensional tolerance in the region of the axial fixing and a corresponding reduction in axial play can lead to a reduction in sound emissions. The finer dimensional tolerance however entails high production costs and nonetheless still does not give satisfactory results with respect to noise reduction.

### SUMMARY

What is needed is to provide a brake caliper arrangement for a disc brake, and a disc brake with a brake caliper arrangement and an electromechanically driveable spindle drive, which generate lower sound emissions during operation of an associated motor vehicle, and which can be produced more cheaply and are easy to install.

A brake caliper arrangement with the features of claim 1 and by a disc brake with the features of claim 12 is disclosed herein. Other exemplarily arrangements are given in the dependent claims 2 to 11.

Where, in connection with the brake caliper arrangement, reference is made to the disc brake or its constituents, e.g. a brake disc, this serves the purpose of clearly defining the different elements of the brake caliper arrangement and presenting the advantages of the elements of the brake caliper arrangement over the prior art. Also where, in connection with the brake caliper arrangement and the disc brake, reference is made to a motor vehicle, this also serves the purpose of clearly defining the different elements of the brake caliper arrangement and disc brake and presenting the advantages of the disclosure over the prior art.

The brake caliper arrangement according to the disclosure comprises a brake caliper which has a housing with a cavity, a brake piston which is mounted axially movably in the cavity, a spindle drive having a spindle which is mounted in the cavity so as to be rotatable relative to the housing and having a spindle nut which is axially driveable via the spindle and is mounted axially displaceably. The spindle drive can be actuated such that it can be placed in a first actuation state and in a second actuation state. The spindle nut in the first actuation state exerts a force F1 on the brake piston in the axial direction x, and the spindle nut in the second actuation state exerts no force on the brake piston in the axial direction x. The brake caliper arrangement has a clamping device which exerts a force F2 on the spindle in the axial direction x such that, in the second actuation state of the spindle drive, the spindle is mounted play-free relative to the housing in the axial direction.

The term “axial” or “in the axial direction” relates to the orientation of the rotational axis of an associated brake disc which, in installed state, sits in the floating caliper brake and, in driving mode of an associated vehicle, rotates about the rotational axis. In other words, “in the axial direction” means parallel to the rotational axis or running along the rotational axis.

It should be noted that the absence of play is ensured by the clamping device. The elimination of axial play enables the clamping device to reduce the sound emissions generated by the spindle in its interplay with other components of the brake caliper arrangement during operation of an associated motor vehicle, in comparison with brake caliper arrangements of the prior art. Even when there are dimensional tolerances, which allow greater dimensional fluctuations, in production of the spindle and elements axially fixed in the housing with the spindle so that an axial play exists in any case, the clamping device ensures that this play too is eliminated. Because of the clamping device, under normal operating conditions, the spindle can no longer move to and fro in the axial direction, or at least not unhindered. This leads to a reduction in sound emissions. Further, the clamping device contributes to a cheaper production of the spindle and its mounting since, with respect to axial fixing, comparatively great tolerance classes can be selected.

The force F2 which the clamping device applies to the spindle eliminates any existing axial play between spindle and housing. Because the absence of play results from the clamping device, the brake caliper arrangement and, more specifically, the spindle drive, can easily be mounted.

In one exemplary arrangement, the spindle has a first end with a threaded portion via which the spindle nut can be driven, and a second end with a drive portion which is arranged opposite the first end in the axial direction. The clamping device may be arranged in the region of the second end. The clamping device may be arranged both in the region of the second end and also in the region of the drive portion, since the second end comprises the drive portion. “In the region of the second end” or “in the region of the drive portion” means that the clamping device is arranged in the axial direction at least partially overlapping with the second end or the drive portion, or with both the second end and also the drive portion. This arrangement of the clamping device allows simple mounting of the clamping device and also of the spindle arrangement.

In one exemplary arrangement, the brake caliper has a channel in which, when the brake caliper arrangement is mounted on an associated disc brake and an associated vehicle, a brake disc is or can be arranged so as to be rotatable about its rotational axis, wherein the cavity has an opening towards the channel such that, when the disc brake is arranged on an associated vehicle, the brake piston can displace one or more provided brake pads towards the brake disc in the axial direction x.

In one exemplary arrangement, the brake piston is formed pot-like such that a brake piston interior is present between an end wall oriented towards the channel and a piston wall via which the brake piston is guided axially movably in the cavity. The spindle drive is arranged at least partly in the brake piston interior. The end wall in the brake piston interior has a stop face and wherein the spindle nut has a pressing face which is oriented towards the stop face and, in the first actuating state of the spindle drive, is in contact with the stop face and exerts the force F1 thereon. In one exemplary arrangement, the piston wall is cylindrical.

In one exemplary arrangement, the housing has a bottom which delimits the cavity in the region of its lowest point, viewed from the opening, wherein the bottom has a bottom inside arranged towards the cavity, a bottom outside which is part of a housing outside of the housing, and a passage. The bottom outside may also or alternatively be part of a mechanical interface region of the housing. The first end of the spindle here protrudes into the brake piston interior and the second end of the spindle protrudes through the passage from the cavity to the bottom outside. The spindle has a bearing portion arranged between the first end and the second end. The bearing portion may also, or alternatively, be arranged between the threaded portion and the drive portion. Furthermore, a rotation bearing, which guarantees the rotatability of the spindle, is arranged in the cavity between the bottom and the bearing portion, wherein in the second actuation state of the spindle drive, the clamping device preloads the rotation bearing play-free in the axial direction x.

In one exemplary arrangement, the clamping device is arranged in the region of the housing outside or in the region of the mechanical interface region of the housing. The clamping device may be arranged both in the region of the housing outside and in the region of the mechanical interface region of the housing. In this case, the mechanical interface region may be a part region of the housing outside. These above-mentioned arrangements of the clamping device also allow simple mounting of the clamping device and also of the spindle arrangement.

In one exemplary arrangement, the clamping device creates a force flow between a first support face of a support arrangement, for example, a support disc, and a second support face which is axially spaced from the first support face. Here, the support arrangement is connected to the second end of the spindle, for example, by form fit. The second support face is provided by the bottom outside. In one exemplary arrangement, there is a distance between the first support face and the second support face.

In one exemplary arrangement, the clamping device has a spring which is axially preloaded between the first support face and the second support face. This means that the spindle and the bearing and securing elements can easily be assembled, since the preload is generated by the spring. The spring is a low-cost, elastic component and eliminates the axial play and hence reduces the sound emissions. The spring may be configured as a metal spring.

In one exemplary arrangement, the spring is configured as a ring or a disc. For example, in this case (ring/disc), the spring has three wave-like cutouts in the axial direction x, such that the spring is in contact with both the first and second support faces at three points. This design of the spring ensures optimal transmission of the force F2 to the spindle over the circumference of the ring or disc, and hence an optimal reduction in sound emissions.

In connection with the use of an above-mentioned spring or spring washer, there is a distance between the first support face and second support face. In one exemplary arrangement, the distance lies in a range between 1 mm and 3 mm. In another exemplary arrangement, the distance is between 1.3 mm and 2.5 mm. In a further exemplary arrangement, the distance is between 1.5 mm and 2 mm.

In one exemplary arrangement, the second support face in the bottom outside is arranged, sunk towards the bottom inside. This sinking provides installation space for the clamping device. It is thus possible to retrofit existing brake caliper and disc variants, without changing the installation dimensions or mechanical interfaces of the brake caliper arrangement.

In one exemplary arrangement, the support arrangement comprises a first support disc with a first support disc side and a second support disc side opposite the first support disc side, wherein the first support disc side comprises the first support face and the second support disc side is in active contact with a ring groove provided by the second end of the spindle. In one exemplary arrangement, the first support disc is in active contact by form fit with the second end of the spindle. In the sense of the disclosure, the first support disc may be configured as a circumferentially closed disc. It may however also be configured as an undulating securing element, e.g. as a locking ring. Such a locking ring is slotted in the known fashion.

The support arrangement may also comprise a first support disc with a first support disc side and a second support disc side opposite the first support disc side, and a second support disc with a third support disc side and a fourth support disc side opposite the third support disc side. Here, the first support disc and the second support disc are arranged axially successively, such that the first support disc side comprises the first support face, the fourth support disc side is in active contact with a ring groove provided by the second end of the spindle, and the second and third support faces are in active contact with one another. For example, the second support disc is in active contact by form fit with the second end of the spindle. The second support disc in the sense of the disclosure may also be formed as a circumferentially closed disc or as an undulating securing element. In one exemplary arrangement, the first support disc is configured as a circumferentially closed disc, and the second support disc as an undulating locking ring.

The use of one or two support discs contributes to a safer force transmission between the spindle of the clamping device and the housing, and a reduction in vibration which in turn contributes to reducing sound emissions.

In one exemplary arrangement, a lubricant is applied between the second support face and the spring. Alternatively or additionally, a lubricant may be applied between the support device and the spring. The lubricant reduces possible wear on the components concerned and thus in the long-term ensures the functioning of the brake caliper arrangement and the noise-reducing measures. Also, the lubricant itself contributes to reducing the sound emissions.

In one exemplary arrangement, the clamping device is constructed such that, in the second actuation state of the spindle, the force F2 lies in a range from 50N to 100N. In one exemplary arrangement, the force lies in a range from 60N to 90N. Surprisingly, it has been found in tests that a great reduction in sound emissions is achieved in the range from 60N to 90N.

The disc brake according to the disclosure comprises a brake caliper arrangement according to one or more of the above-described exemplary arrangement, wherein the spindle drive can be driven electromechanically. This means that the disc brake or brake caliper arrangement has an interface which readily allows mounting of an electromechanical drive.

### BRIEF DESCRIPTION OF THE DRAWINGS

Further features, advantages and possible applications of the present disclosure arise from the following description of the exemplary arrangements and the schematic FIGS. 1 to 6. For the sake of clarity, not all elements illustrated in a figure carry a reference sign. Corresponding elements or regions are however identified in at least one other figure and the meaning can be gathered from there. Furthermore, the same reference signs may stand for the same or similar objects in the figures.

FIG. 1 shows an illustration of a brake caliper arrangement from the prior art,

FIG. 2 shows an illustration of a brake caliper arrangement according to an exemplary arrangement of the disclosure in a second actuation state,

FIG. 3 shows an illustration of an extract from an exemplary brake caliper arrangement according to the disclosure in a first actuation state,

FIG. 4 shows an illustration of an extract from an exemplary brake caliper arrangement according to the disclosure in a second actuation state,

FIG. 5 shows an illustration of an exemplary arrangement of the spring according to the disclosure, and

FIG. 6 shows an illustration of an exemplary arrangement of the disc brake according to the disclosure.

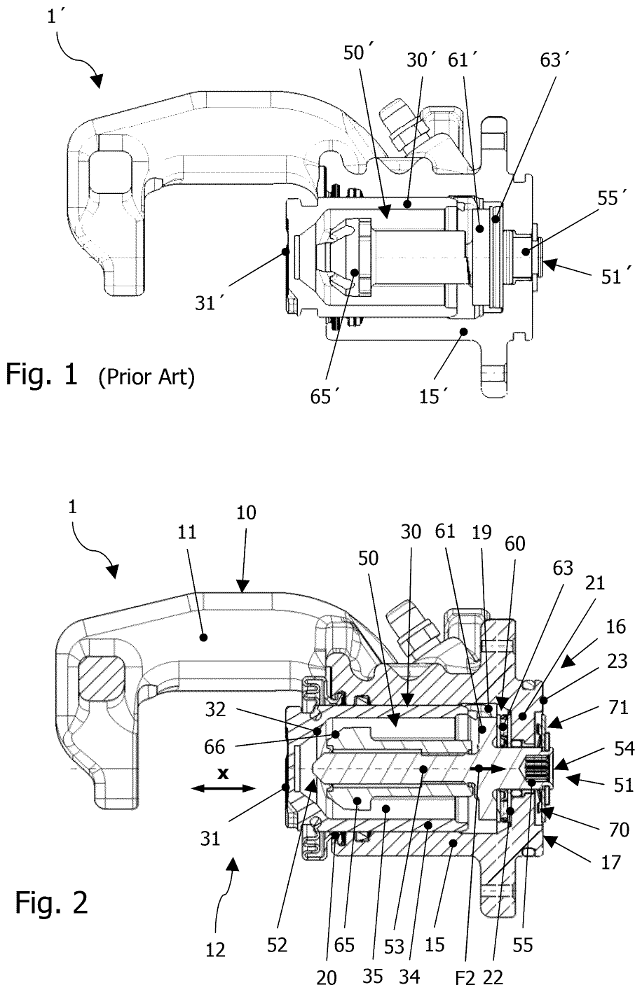

### DETAILED DESCRIPTION

FIG. 2 shows an exemplary arrangement of the brake caliper arrangement 1 according to the disclosure. The brake caliper arrangement 1 has a brake caliper 10 with a carrier structure 11 and a housing 15. Between the carrier structure 11 and the housing 15 is a channel 12 in which a brake disc and brake pads can be received. In the housing 15, a cavity 19 is provided which is open towards the channel 12 and in which a brake piston 30 is mounted so as to be movable in an axial direction x.

The brake piston 30 is pot-like and has an end face or end wall 31 which is closed towards the channel 12, protrudes from the cavity 19 and is open on the opposite side situated in the cavity 19. A cylindrical piston wall 34 surrounds an interior 35 of the brake piston 30. The piston wall 34 is slidingly guided so as to be axially movable in the cavity 19. The cavity 19 of the housing 15 and the interior 35 of the brake piston 30 can be flooded with hydraulic fluid, and the brake piston 30 can thus be hydraulically actuated for service braking.

On the side facing away from the channel 12, the housing 15 has a mechanical interface region 17 on which an electromotorized drive unit or electric motor with gear mechanism can be mounted. The cavity 19 is delimited by a bottom 21 in the region of the mechanical interface 17. The spindle 51 is an elongate component, the longitudinal axis of which extends in the axial direction x. The first end 52 of the spindle has a threaded portion 53, and its second end 54 has a drive portion 55 which is configured as a drive peg. The threaded portion 53 of the spindle and the spindle nut 65 are arranged in the brake piston interior 35, and the drive peg 55 protrudes from the cavity 19 of the housing 15 through a passage 24 situated in the bottom 21 of the housing 15. The drive peg 55 thus extends into the mechanical interface region 17 on the bottom outside 23.

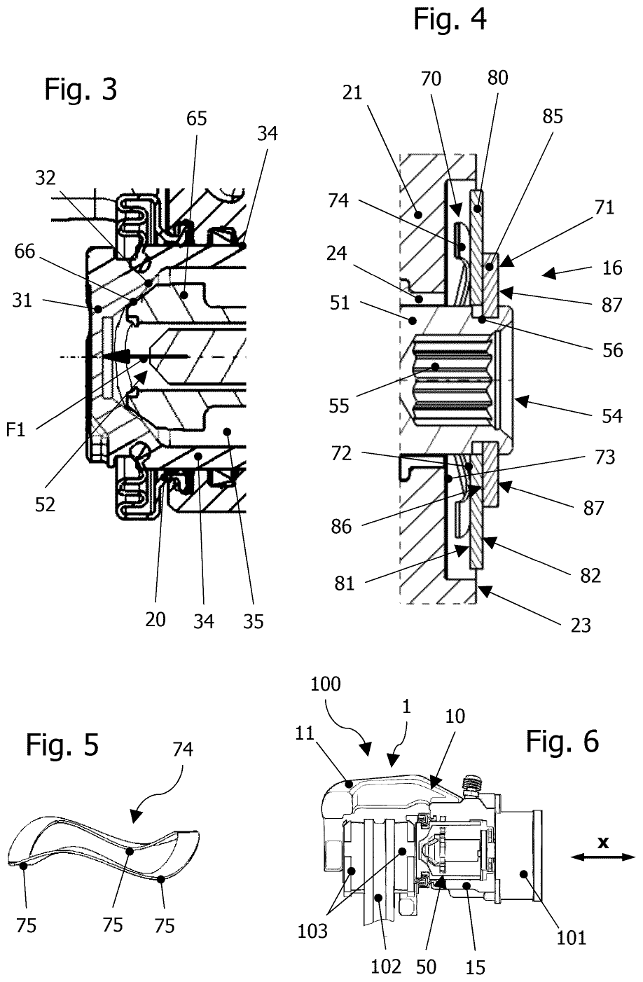

In the interior 35 of the brake piston 30, the spindle drive 50 comprises an axially displaceable spindle nut 65 which can be driven by the spindle 51. The spindle nut 65 is guided twist-securely in the brake piston 30. The spindle drive 50 thus serves to lock the brake piston 30 when the vehicle is stationary (parking brake function) in order to hold the vehicle still. In this case, the spindle drive 50 is driven via the drive peg 55. The parking brake function thus actuated corresponds to a first actuation state of the spindle drive 50 illustrated in FIG. 3.

Between the drive peg 55 and the threaded portion 53, the spindle 51 has a bearing portion 60 comprising a bearing plate 61. On the inside 22 of the bottom 21, situated inside the cavity 19, the spindle 51 is supported by the bearing plate 61 and a rotational bearing 63, which is configured as a thrust bearing and is arranged between the bearing plate 61 and the inner housing bottom 22. On the outside 23 of the bottom 21, the spindle 51 is axially secured relative to the housing 15 by a support arrangement 71. The support arrangement 71 comprises a first support disc 80 configured as a closed disc, and a second support disc 85 configured as a slotted undulating locking ring. The undulating locking ring 85 is held by form fit in a ring groove 56 let into the outer periphery of the drive portion 55 of the spindle 51. The first support disc 80 is formed as a closed disc and bears against the locking ring 85 so that it is closer to the housing outside 23 than the locking ring 85. Between the first support disc 80 and the housing outside 23 is a space in which a undulating spring washer 74 can be arranged under pretension. It is here in contact with the first support face 72 provided by a first support disc side 81, and a second support face 73 provided by the bottom outside 23. The second support face 23 is sunk into the housing outside 16 or the bottom outside 23 in the mechanical interface region 17 so that the spring 74 lies inside the housing bottom 21 in the sectional illustration of FIG. 2.

In a first actuation state of the spindle drive 50, the spindle nut 65 is brought against the inside of the piston end face 31, on which it exerts a force F1 and thus prevents the return of the brake piston 30. This actuation state is illustrated in FIG. 3. The force vector marked as F1 illustrates purely the force direction and the approximate location of the force transfer between the spindle 65 and the end wall 31 of the brake piston 30, but not the precise point of attack, which may be linear or spread, between a conical, spherical or concave pressure face 66 of the spindle nut 65 and a corresponding stop face 32. This state is assumed by the spindle drive 50 when parking brake is activated. In this state, the components of the disc brake 100 which exert or transfer or receive the actuation forces are under axial load because of the activated parking brake function or first actuation state of the spindle drive 50. The brake piston 30 presses against the brake pads which are themselves then pressed against the brake disc. The spindle drive 50 in this state is supported on the bottom inside 22 of the housing 25 via the bearing plate 61 of the spindle 51 and the thrust bearing 63.

In a second actuation state of the spindle drive 50 shown in FIG. 2, the spindle nut 65 is in the retracted position and separated from the inside of the end wall 31 or stop face 32. In this state, the brake piston 30 can be actuated hydraulically as usual in order to perform service braking. When the disc brake is not actuated, the spindle drive 50, in the second actuation state of the spindle drive 50, is not axially clamped by a contact between the spindle nut 65 and the end wall 31 of the brake piston 30. The spindle 51 is indeed axially secured relative to the housing 15 by the bearing plate 61, thrust bearing 63 and above-described support arrangement 71. In this state however, the preloaded spring 74 eliminates or in other words suppresses an axial play between the spindle 51 and housing 15. This prevents the spindle 51 from moving axially to and fro in the housing 15 and thereby generating a noise level. The effect of the noise reduction thus occurs in the second actuating state, in comparison with solutions from the prior art.

FIG. 5 shows an exemplary embodiment of the spring 74. It is configured as a spring washer with three wave-like cutouts 75. In a fitted state, the cutouts each extend in the axial direction. The installation state is shown in FIG. 2 and in an enlarged view in FIG. 4. Because of the three cutouts, the spring touches the first support disc 80 at three points on its first support side 81, more precisely its first support face 72, and touches the second support face 73 of the bottom outside 23 at three points with a phase offset. Since FIG. 4 is a sectional illustration, the three-point contact is not completely visible in either case.

FIG. 6 shows schematically the structure of an exemplary arrangement of the disc brake 100 according to the disclosure. FIG. 6 serves to clarify the overall structure of such a disc brake 100. The disc brake 100 comprises the brake caliper arrangement 1, a brake disc 102, brake pads 103 and an electromechanical drive 101 via which the spindle drive 50 is driven. The clamping device 70 according to the disclosure is not visible as such in FIG. 6. Reference is made to the above-described FIGS. 2 to 5. The disc brake 100 shown can be combined with all previously described exemplary arrangements of the brake caliper arrangement 1. Vibrations and sound emissions can be amplified by the attached electromechanical drive 101, e.g. by the housing of the electromechanical drive 101. For this reason, the disclosure is advantageous in combination with an attached electromechanical drive. Amplification of even small sound emissions originating from the spindle 51 and spindle drive 50 according to the disclosure has less of a negative effect on the total emitted noise of the disc brake 100. In other words, the total sound emissions of the disc brake 100 are also reduced.

1. A brake caliper arrangement for a disc brake, comprising:
a brake caliper having a carrier structure and a housing with a cavity,
a brake piston which is mounted axially movably in the cavity, and
a spindle drive having a spindle mounted in the cavity so as to be rotatable relative to the housing and having a spindle nut which is axially drivable via the spindle and mounted axially displaceably,
wherein the spindle drive can be actuated such that the spindle drive can be placed in a first actuation state and in a second actuation state, wherein the spindle nut in the first actuation state exerts a force on the brake piston in the axial direction x, and wherein the spindle nut in the second actuation state exerts no force on the brake piston in an axial direction,
wherein the brake caliper arrangement has a clamping device which exerts a force on the spindle in the axial direction x such that, in the second actuation state of the spindle drive, the spindle is mounted play free relative to the housing, in the axial direction x.

2. The brake caliper arrangement according to claim 1, wherein the spindle has a first end with a threaded portion via which the spindle nut can be driven, and a second end with a drive portion which is arranged opposite the first end in the axial direction, wherein the clamping device is arranged in the region of the second end and/or in the region of the drive portion.

3. The brake caliper arrangement according to claim 1, wherein
the brake caliper has a channel in which, when the brake caliper arrangement is arranged on an associated disc brake and an associated vehicle, a brake disc is or can be arranged so as to be rotatable about its rotational axis, wherein the cavity has an opening towards the channel such that when the brake caliper arrangement is arranged on an associated disc brake and an associated vehicle, the brake piston can displace one or more provided brake pads towards the brake disc in the axial direction x,
wherein the brake piston is formed pot like such that a brake piston interior is present between an end wall oriented towards the channel and a piston wall via which the brake piston is guided axially movably in the cavity,
wherein the spindle drive is arranged at least partly in the brake piston interior,
wherein the end wall in the brake piston interior has a stop face,
wherein the spindle nut has a pressing face which is oriented towards the stop face and, in the first actuating state of the spindle drive, is in contact with the stop face and exerts the force thereon,
wherein the housing has a bottom which delimits the cavity in the region of its lowest point, viewed from the opening,
wherein the bottom has
a bottom inside arranged towards the cavity,
a bottom outside which is part of a housing outside of the housing and/or part of a mechanical interface region of the housing, and
a passage,
wherein the first end of the spindle protrudes into the brake piston interior and the second end of the spindle 5 protrudes through the passage from the cavity to the bottom outside,
wherein the spindle has a bearing portion arranged between the first end and the second end,
wherein a rotation bearing, which permits the rotatability of the spindle, is arranged in the cavity between the bottom and the bearing portion, and wherein in the second actuation state of the spindle drive, the clamping device preloads the rotation bearing play free in the axial direction.

4. The brake caliper arrangement according to claim 3, wherein the clamping device is arranged in a region of the housing outside and/or in a region of the mechanical interface region of the housing.

5. The brake caliper arrangement according to claim 3, wherein the clamping device creates a force flow between a first support face of a support arrangement, which is part of the second end of the spindle or is connected to the second end of the spindle, and a second support face which is axially spaced from the first support face and is provided by the bottom outside.

6. The brake caliper arrangement according to claim 5, wherein the clamping device has a spring which is axially preloaded between the first support face and the second support face.

7. The brake caliper arrangement according to claim 6, wherein the spring is configured as a disc or ring, and/or wherein the spring is configured as a disc or ring which has three wave like cutouts in the axial direction such that the spring is in contact with both the first and second support faces at three points.

8. The brake caliper arrangement according to claim 5, wherein the second support face in the bottom outside is arranged sunk towards the bottom inside.

9. The brake caliper arrangement according to claim 5, wherein the support arrangement comprises a first support disc with a first support disc side and a second support disc side opposite the first support disc side,
wherein the first support disc side comprises the first support face and the second support disc side is in active contact with a ring groove (5 provided by the second end of the spindle.

10. The brake caliper arrangement according to claim 6, wherein a lubricant is applied between the second support face and the spring and/or between the support arrangement and the spring.

11. The brake caliper arrangement according to claim 1, wherein the clamping device is configured such that in the second actuation state of the spindle, the force lies in a range from 40N to 100N.

12. A disc brake with a brake caliper arrangement according to claim 1, wherein the spindle drive can be driven electromechanically.

13. The brake caliper arrangement according to claim 4, wherein the clamping device creates a force flow between a first support face of a support arrangement, which is part of the second end of the spindle or is connected to the second end of the spindle, and a second support face which is axially spaced from the first support face and is provided by the bottom outside.

14. The brake caliper arrangement according to claim 6, wherein the second support face in the bottom outside is arranged sunk towards the bottom inside.

15. The brake caliper arrangement according to claim 5, wherein the support arrangement comprises a first support disc with a first support disc side and a second support disc side opposite the first support disc side,
wherein the support arrangement comprises a first support disc with a first support disc side and a second support disc side opposite the first support disc side, and a second support disc with a third support disc side and a fourth support disc side opposite the third support disc side, wherein the first support disc and the second support disc are arranged axially successively such that the first support disc side comprises the first support face, the fourth support disc side is in active contact with a ring groove provided by the second end of the spindle, and the second and third support disc sides are in active contact with one another.

16. The brake caliper arrangement according to claim 15, wherein a lubricant is applied between the second support face and the spring and/or between the support arrangement and the spring.
